(19) United States
(12) Patent Application Publication
(10) Pub. No.: US 2007/0002451 A1
(43) Pub. Date: Jan. 4, 2007

(54) Lenticular display assembly and method

(76) Inventor: Michael Summerlin, Quebec (CA)

Correspondence Address: BROOKS KUSHMAN P.C., 1000 TOWN CENTER, TWENTY-SECOND FLOOR, SOUTHFIELD, MI, 48075, US

(21) Appl. No.: 10/595,374

(22) PCT Filed: Oct. 15, 2004
(86) PCT No.: PCT/CA04/01830

§ 371 Date: Apr. 13, 2006

(30) Foreign Application Priority Data
Oct. 17, 2003 (CA) 2445368

(51) Int. Cl. G02B 27/10

(52) U.S. Cl. 359/619

(57) ABSTRACT

A lenticular display assembly comprises an image panel having a composite image. A lenticular lens panel is adapted to display a lenticular image from a composite image. Connection means are provided to releasably connect the image panel to the lenticular lens panel in an aligned relationship. Compression means are provided to press the image panel and the lenticular lens panel connected to one another by the connection means, whereby the lenticular image is displayed by the lenticular lens panel and the image panel being interconnected by the connection means and the compression means.

### CROSS-REFERENCE TO RELATED APPLICATION

This application claims priority on Canadian Patent Application No. 2,445,368, filed on Oct. 17, 2003.

### TECHNICAL FIELD

The present invention generally relates to lenticular displays and, more particularly, to an assembly for displaying lenticular images, for instance in a backlit configuration, and a method for producing prealigned lenticular images.

### BACKGROUND ART

Lenticular imagery has been available for many years and involves the alignment of a composite image to an optical screen which when viewed from different angles can depict different images and, for instance, movement and depth. As a single panel incorporates at least two images or a movement in an image, lenticular images are known to attract viewers, and induce a stopping power and staying power on the viewers. Composite images are typically bonded or laminated to the lenticular lens to form a lenticular display.

The alignment between the composite image and the lenticular lens must be precise in order for the lenticular display to produce the desired visual effect from the different viewpoints. At present, the composite image and lenticular image are often aligned by eye. This is a very tedious task and, if an error is made, both the image and lenticular lens are normally wasted, considering that they are bonded/laminated to one another. The cost of the lenticular lens, the lamination, the labour required to align the image, the packing and transportation (handling) of a flat object make the end product expensive and unwieldy and has resulted in slow growth in the lenticular image industry.

### SUMMARY OF INVENTION

Therefore, it is a feature of the present invention to provide a novel lenticular display assembly.

It is a further feature of the present invention to provide a lenticular display assembly in which a lenticular lens and an image panel are releasably connected.

It is a still further feature of the present is invention to provide a method for releasably connecting a lenticular lens and an image panel to form a lenticular lens assembly.

It is a still further feature of the present invention to provide a method for prealigning images to a lenticular lens.

Therefore, in accordance with the present invention, there is provided a lenticular display assembly, comprising: an image panel having a composite image; a lenticular lens panel adapted to display a lenticular image from a composite image; connection means provided to releasably connect the image panel to the lenticular lens panel in an aligned relationship; and compression means provided to press the image panel and the lenticular lens panel against one another; whereby the lenticular image is displayed by the lenticular lens panel and the image panel being interconnected by the connection means and the compression means.

Further in accordance with the present invention, there is provided a method for displaying a lenticular image, comprising the steps of: i) providing a lenticular lens panel and an image panel; ii) positioning the lenticular lens panel onto the image panel such that the lenticular lens panel is in a desired alignment relationship with respect to a composite image on the image panel; and iii) pressing the panels such that the image panel is pressed against the lenticular lens panel; whereby a lenticular image is displayed by the combination of the panels.

Still further in accordance with the present invention, there is provided a method for aligning an image panel with a lenticular lens panel, comprising the steps of i) positioning at least one image panel on a support surface; ii) positioning a reference lens panel on the at least one image panel, the reference lens panel having a known alignment with respect to the lenticular lens panel; iii) adjusting a position and orientation of the reference lens panel with the at least one image panel such that the reference lens panel is aligned with the at least one image panel to display a desired lenticular image; and iv) creating connection holes in the at least one image panel; whereby the image panel is aligned for the lenticular lens panel as a function of said known alignment.

This invention incorporates a method of automatically aligning the image by register and sandwich system for compressing the image and lenticular lens so that the lenticular material, the lamination, the labour and handling are all either reduced or eliminated. The lenticular material stays in the display unit and only the image is substituted. The registration system and the compression system combined make the task of changing images compatible with the unskilled labour commonly used for this task resulting in a simple display system which will accept both 2D and 3D images and enabling either to be displayed at lowered costs.

The invention provides a means of displaying both reflective and backlit composite images without adhering them to the lenticular material and having an easy way of changing the images without having to align or adjust them on site. To achieve this, the present invention provides a registration method, which guarantees the integrity of all parts of the display unit so that any part can be interchanged and still maintain the alignment providing the pitch of the lens and the image match.

The lenticular material is laid on a flat vacuum light table which has prepositioned drilling guides mounted at one end and has a surface printed with parallel lines, or a removable lined panel. The lens is positioned under the drilling guides and located with a pin which registers into one of the lenticular groves securing the lens and acting as a pivot. This enables the lens to be turned until the parallel lines can be seen clearly. The vacuum is applied and holes are drilled in the lens through the drilling guides to provide accurate perforations always at the same location point relative to the lenticules.

One sheet of aligned lens is kept as a master and fixed to a hinged plate at the head the light table. The images are aligned to this master lens, the vacuum light table swings into the vertical position where the image can be viewed vertically through the lens, both image and lens being held by vacuum. Minor adjustments can be made in this position, the table returned to the horizontal position and the image perforated in the same manner as the lens.

A backing plate may also be perforated at the same registration points.

To display the image, the lens, the image and the backing plate are curved by mechanical means to form a slight curvature. The curvature forces the three components together into intimate contact. The image can be changed by releasing the fasteners and separating the components.

### BRIEF DESCRIPTION OF DRAWINGS

A preferred embodiment of the present invention will now be described with reference to the accompanying drawings in which:

FIG. 1A is a perspective view, from a rear point of view, of a table for aligning lenticular assembly panels in accordance with an embodiment of the present invention, with a support surface in a vertical position;

FIG. 1B is a perspective view of the table of FIG. 1A, with the support surface in a horizontal position;

FIG. 1C is a perspective view, from a front point of view, of the table of FIG. 1A;

FIG. 2 is an enlarged perspective view of an adjustable clamping system of the table of FIG. 1A;

FIG. 3 is a perspective view of the table having a lined image for alignment of a master lens;

FIG. 4 is a perspective view of the table, with a composite image panel being aligned with the master lens;

FIG. 5A is a front elevation view of a jig for aligning lenticular assembly panels in accordance with the present invention;

FIG. 5B is an exploded view of the jig of FIG. 5A, with various lenticular assembly panels between members of the jig;

FIG. 6A is an exploded view of a lenticular display assembly in accordance with a further embodiment of the present invention;

FIG. 6B is a perspective view of the lenticular display assembly of FIG. 6A;

FIG. 6C is an enlarged view of fasteners of the lenticular display assembly of FIG. 6A;

FIG. 7 is a lenticular display assembly in accordance with a still further embodiment of the present invention;

FIG. 8 is a lenticular display assembly in accordance with a still further embodiment of the present invention;

FIG. 9A is a perspective view, from a rear point of view, of a lenticular display assembly in accordance with a still further embodiment of the present invention;

FIG. 9B is an exploded view of a compression means of the lenticular display assembly of FIG. 9A;

FIG. 10 is a schematic view of a lenticular display assembly with a suspended cable support configuration;

FIG. 11 is a schematic view of a lenticular display assembly with support bars of a support configuration in accordance with a still further embodiment of the present invention; and

FIG. 12 is a schematic view of a lenticular display assembly as supported by a base support of a support configuration in accordance with a still further embodiment of the present invention.

### DESCRIPTION OF PREFERRED EMBODIMENTS

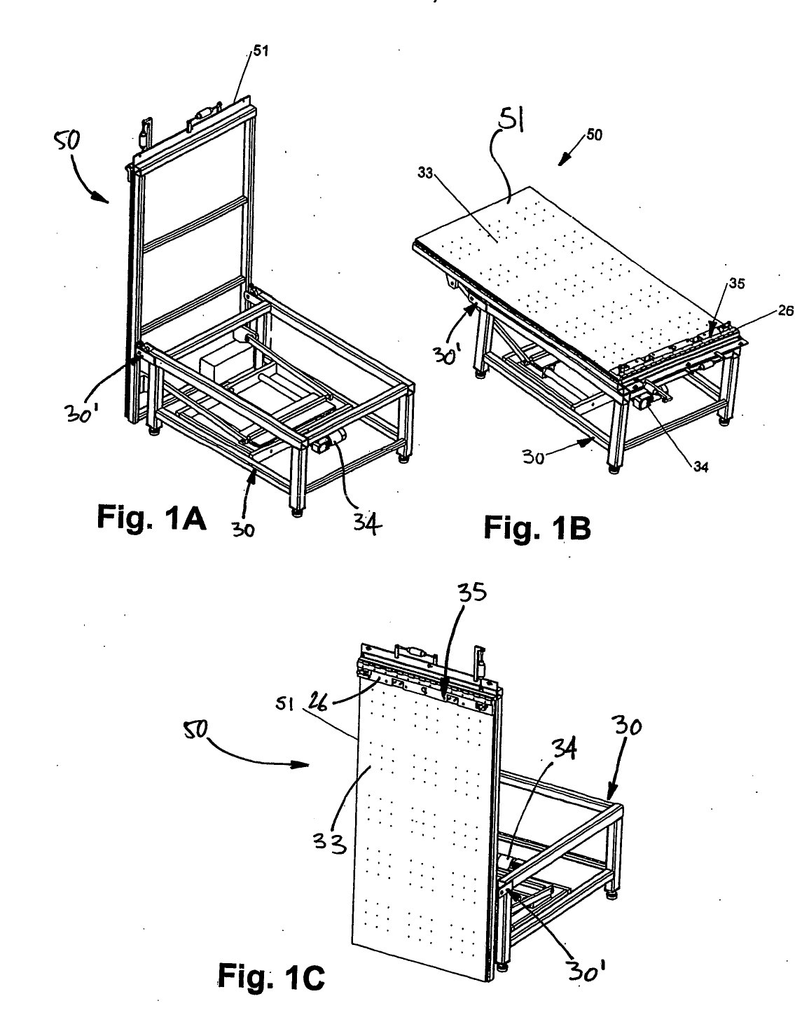

Referring to the drawings, and more particularly to FIGS. 1A, 1B and 1C, a table for alignment of lenticular assembly panels in accordance with an embodiment of the present invention is generally shown at 50. The table 50 has a support surface 51, which is shown in a horizontal position in FIG. 1B, an in a vertical position in FIGS. 1A and 1C. The table 50 typically consists of a light-diffusing vacuum table, having perforations 33 on the surface of the support surface 51 to hold down material placed thereon. Channels or a plenum, connected to a vacuum source, are provided on an undersurface of the support surface 51 to course suction through the perforations 33.

Framework 30 is a typical structure, for instance of tubular steel. The framework 30 has a pivoting mechanism, generally shown at 30′, so as to pivotally support the support surface 51, such that the latter is displaceable between the horizontal position of FIG. 1B and the vertical positions of FIGS. 1A and 1C.

The support surface 51 typically consists of light-diffusing plastic material, such that a light source positioned under the support surface 51 may be used to illuminate the support surface 51 and panels positioned thereon. The displacement of the support surface 51 may be assisted by means of a lever system driven by a motor, as generally illustrated by 34.

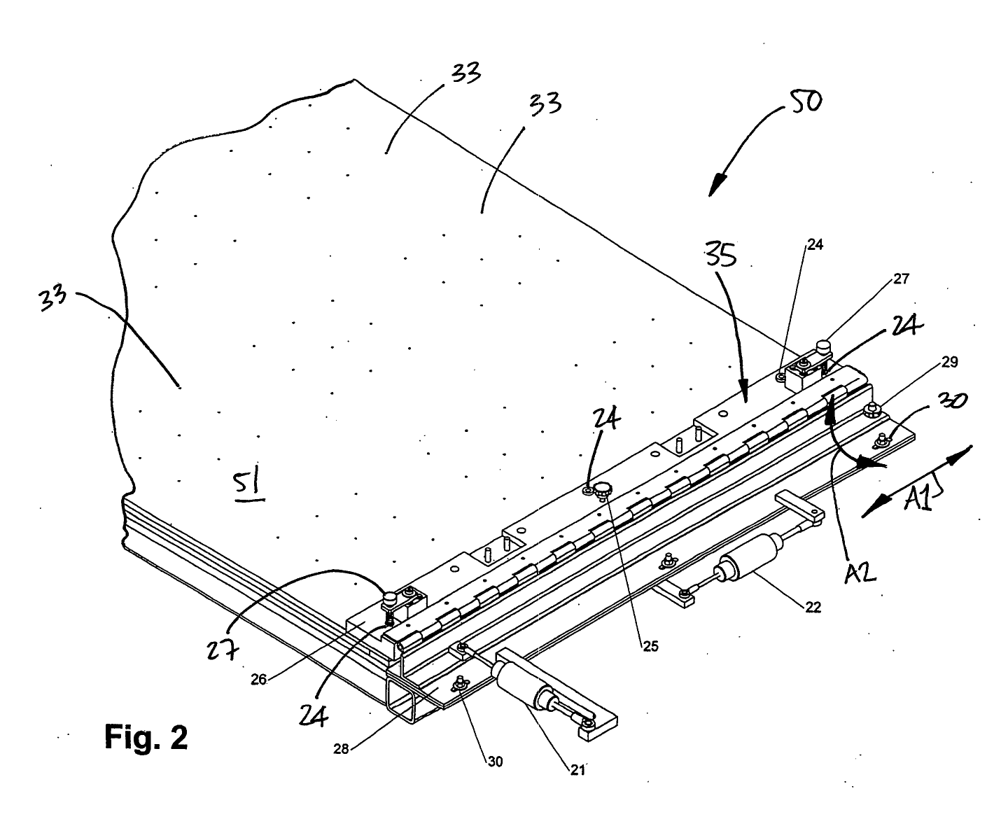

An adjustable clamping system 35 with drilling and perforating guides is mounted at the head of the table 50. Referring now to FIG. 2, the adjustable clamping system 35 consists of a hinged clamp 26 with perforating and drilling guides 24 placed at predetermined intervals. A spring-loaded lenticule locating pin 25 and two removable lens locating pins 27 are provided on the hinged clamp 26. A mounting plate 28 is displaceable in translation along direction A1 by way of slots 30, and in translation along direction A2 by way of pin 29. Movement of the mounting plate 28 is controlled by a micro adjustment system, having a rotation member 21 and a translation member 22.

Now that the table 50 has been generally described a method for prealigning lenticular assembly panels using the table 50 is now described.

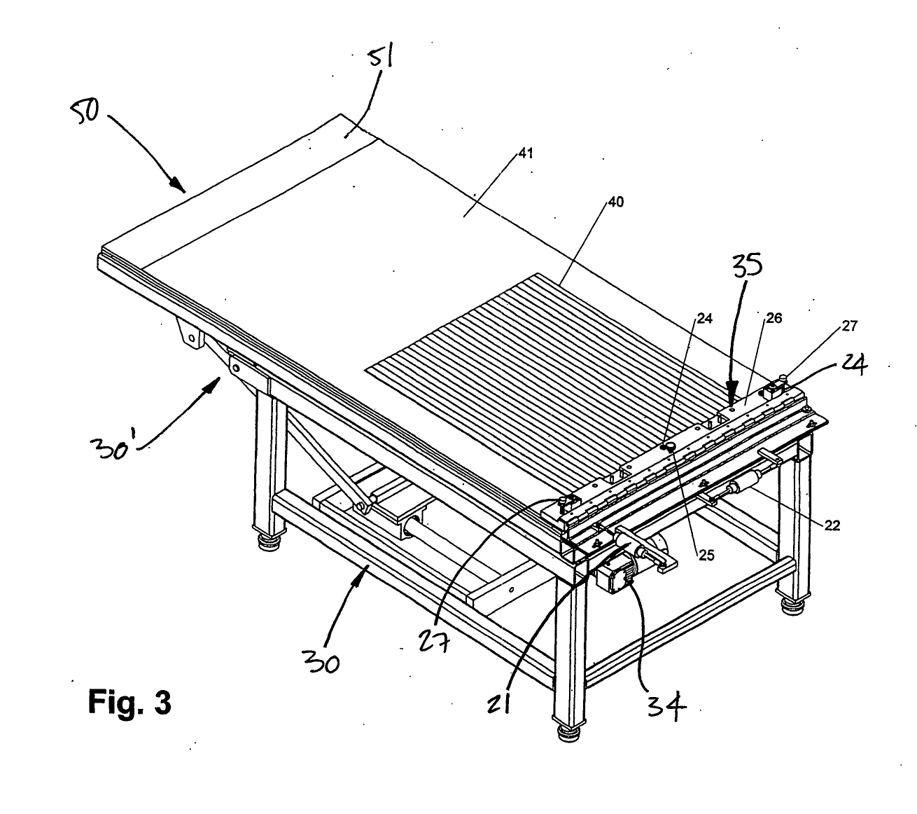

In an embodiment of the present invention, a reference lens (hereinafter a “master lens”) is initially required, as the master lens will be used for the subsequent alignment of other panels, such as composite image panels. Referring to FIG. 3, a lined image 40 is positioned onto the support surface 51 of the table 50, and remains in position thereon by way of the suction exerted by the perforations 33. The lined image 40 consists of a printout sheet having a plurality of parallel lines. The image 40 is positioned onto the support surface 41 such that the parallel lines on the image 40 are substantially perpendicular to the hinged clamp 26.

Thereafter, a master lens 41 is positioned onto the support surface 51, such that the image 40 is sandwiched between the lens 41 and the support surface 51. The master lens 41 extends beyond the image 40 under the clamp 26, such that the master lens 41 is secured by the clamp 26 (e.g., using the locating pin 25). The orientation alignment of the master lens 41 is performed using the locating pin 25, so as to have the lenticules of the master lens 41 substantially parallel to the lines of the lined image 40 (i.e., the lines of the image will be clearly visible through the master lens 41).

Once a satisfactory visual alignment of the master lens 41 with respect to the lined image 40 is achieved, holes are drilled through the master lens 41, using the perforating/drilling guides 24 (with the locating pins 27 removed). The axis of the drilled holes will be generally normal to the lenticules of the master lens 41.

This procedure for perforating connection holes into various panels of a lenticular display assembly, with respect to a reference panel and a template image, such as the lined image 40, may be repeated for other panels, as will be described hereinafter. It is also pointed out that the lined image 40 could be substituted by permanent lines provided on the support surface 51.

With the master lens 41, the table 50 is used to perforate connection holes into composite images, such that the holes are suitably positioned into the composite images for subsequent use in a lenticular lens assembly.

More particularly, referring to FIG. 4, a composite image panel 2 is positioned onto the support surface 51 of the table 50, and is secured thereon by the suction exerted through the perforations 33. The master lens 41 is positioned onto the composite image panel 2, under the clamp 26, such that the holes previously made in the master lens 41 are in register with the drilling guides 24. The locating pins 27 are used to ensure that the master lens 41 is suitably positioned in the clamping mechanism 35. The locating pin 25 is used to adjust the orientation of the master lens 41 with respect to the drilling guides 24.

Once the master lens 41 is aligned with the drilling guides 24, the rotation and translation members 21 and 22 of the adjusting mechanism are used to align the master lens 41 with the composite image panel 2, so as to obtain the desired lenticular visual effect from the combination of the master lens 41 and the composite image panel 2.

The backlit feature of the table 50, as well as the pivoting feature thereof, ensure a precise and accurate alignment of the master lens 41 with the composite image panel 2. More precisely, the support surface 51 is advantageously pivoted to its vertical position (FIGS. 1A and 1C), and illuminated, to enhance the lenticular visual effect of the master lens 41/composite image panel 2 combination, The rotation and translation members 21 and 22 of the adjusting mechanism are used for fine position and orientation adjustments.

Once a satisfactory alignment is obtained, holes are perforated in the composite image panel 2 using the drilling guides 24, whereby connection holes are now defined in the composite image panel 2. These connection holes are in register with the connection holes of the master lens 41, such that the superposition of the composite image panel 2 and the master lens 41 will produce the desired lenticular visual effect. The master lens 41 is thus used as a template for precisely positioning connection holes into composite image panel 2 and other components of lenticular lens assemblies.

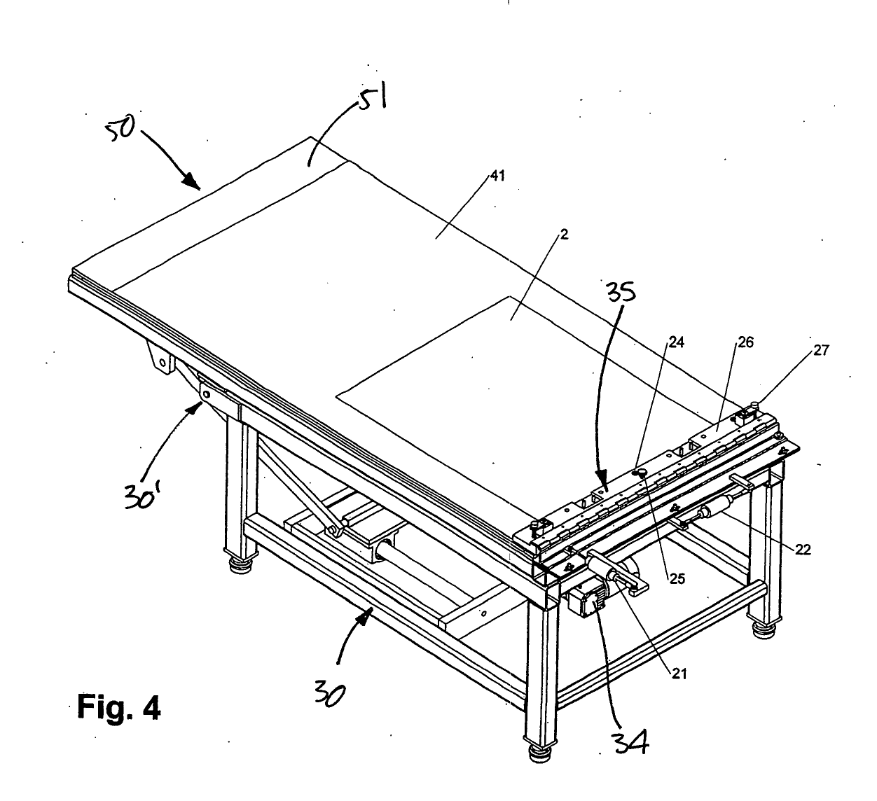

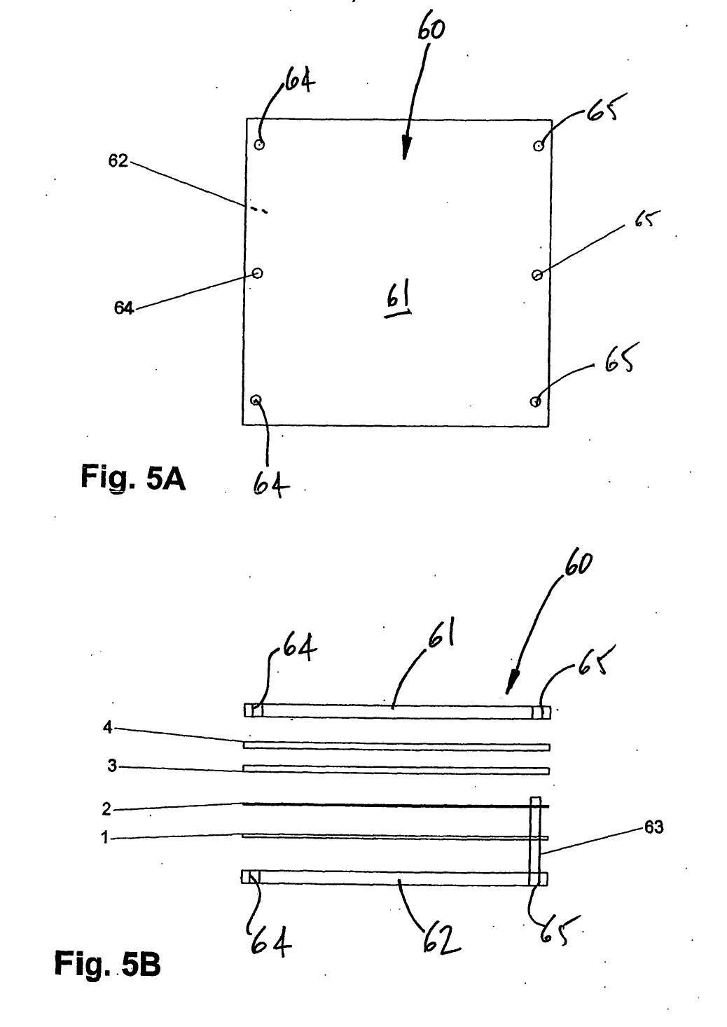

Referring to FIGS. 5A and 5S, a jig in accordance with another embodiment of the present invention is generally shown at 60. The jig 60 is used to produce connection holes at an opposed unperforated end of the panels. The jig 60 has plates 61 and 62, between which the various panels of the present invention (e.g., lenticular panel 1, image panel 2, backplate 3, tension plate 4, as will all be described hereinafter) are sandwiched.

Each of these panels has been provided with connection holes at an upper end, using the table 50 as described previously. Bars 63 (one of which is shown) are used with alignment holes 65 to align the panels with the plates 61 and 62, whereby the panels are aligned in position and orientation. Thereafter, connection holes are perforated at a bottom end of the panels, using the drilling guides 64 in the plates 61 and 62.

It is pointed out that some types of composite image printing (e.g., lithography) produce reproducible results, whereby a plurality of composite images may be stacked, such that connection holes may be made in a plurality of images at once. Such a procedure results in the above-described alignment procedure being performed only once for a plurality of panels, whereby substantial time savings result from this action.

In order for the assembly of the lenticular screen and the composite image panel to produce the desired lenticular visual effect, the composite image panel must be aligned in position and orientation with the lenticular screen, and the front surface of the composite image panel must be coplanar with the rear surface of the lenticular screen.

Therefore, in accordance with an embodiment of the present invention, a lenticular display assembly has components that will ensure that the composite image panel and the lenticular screen are in a coplanar relationship.

More specifically, the lenticular display assembly of the present invention connects the composite image panel and the lenticular screen to one another, and bends these panels into a curve, which causes the lenticular panel and the composite image panel to be pressed against one another in such a way that the front surface of the composite image panel is coplanar with the rear surface of the lenticular panel. Accordingly, the desired lenticular visual effect is produced with the lenticular display assembly of the present invention.

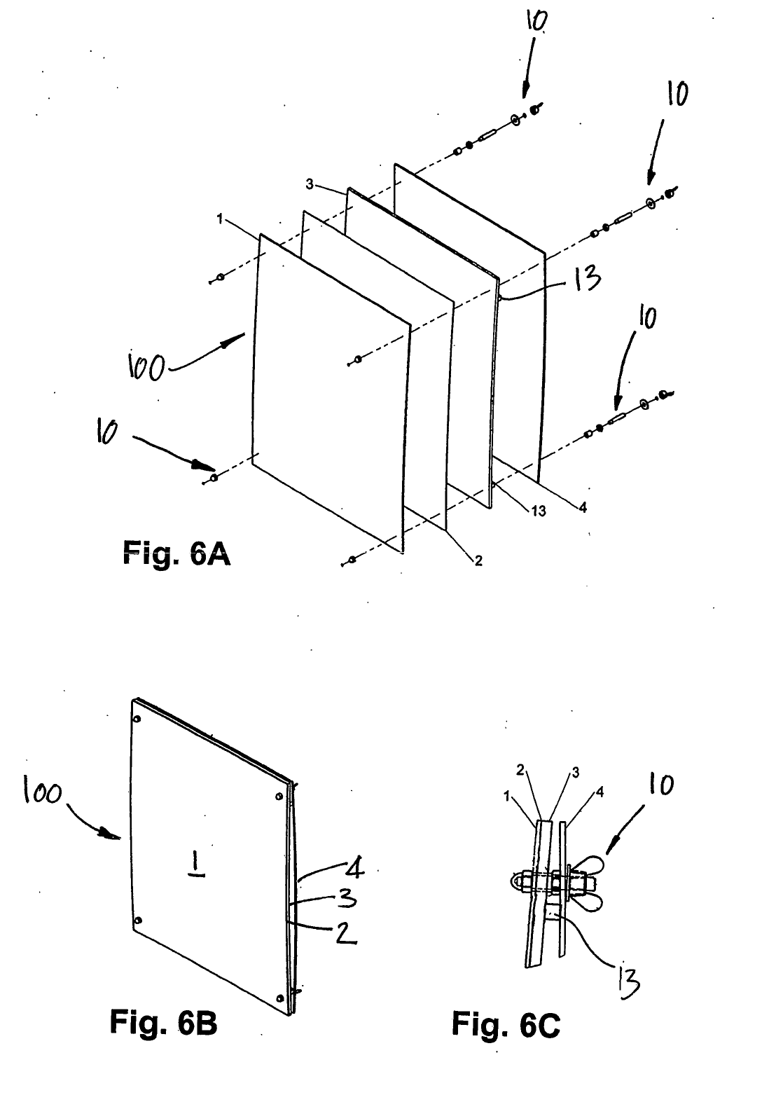

Referring to FIGS. 6A, 6B and 6C, a lenticular display assembly in accordance with a further embodiment of the present invention is generally shown at 100. The lenticular image assembly 100 has a lenticular lens 1 (i.e., lenticular panel), a composite image panel 2, and a backplate 3. A tension plate 4 may optionally be used in the assembly 100, along with stress bars 13.

More particularly, the lenticular lens 1 and the composite image panel 2 are combined to one another to produce lenticular visual effects, such as movement or different images from different viewing angles. As mentioned previously, the lenticular lens 1 and the composite image panel 2 must be aligned in both position and orientation so as to produce the desired lenticular visual effects. Moreover, the rear surface of the lenticular lens 1 must be coplanar with the front surface of the composite image panel 2 so as to produce the desired results.

Accordingly, the connection holes in the lenticular lens 1, the composite image 2 and the backplate 3 are made using the table 50. The lenticular lens 1, the composite image 2 and the backplate 3 are interconnected (e.g., using releasable fasteners 10), such that when interconnected to one another, as illustrated in FIG. 6B, the lenticular lens 1, the composite image 2 and the backplate 3 are slightly curved due to the effect of the tension plate 4 and the stress bars 13. As shown in FIG. 6B, the assembly of the lens 1/image 2/backplate 3 is concave from a front standpoint of this assembly.

The curvature in the assembly ensures that the image 2 is flush against the lens 1. Moreover, this curvature is created by the positioning of the connection holes in the lens 1/image 2/backplate 3, which positioning was also made as a function of position and orientation alignment of the lens 1 with the composite image 2.

It is pointed out that the curvature in the assembly is one contemplated way of interrelating the various panels of the lenticular display assembly of the present invention. However, it is also contemplated to use any other compression means to press the image panel 2 to the lens 1 to produce the lenticular display. For instance, an expandable vessel (e.g., bladder), vacuuming systems and the like can be used as compression means to ensure that the front face of the image 2 is coplanar with the rear face of the lens 1.

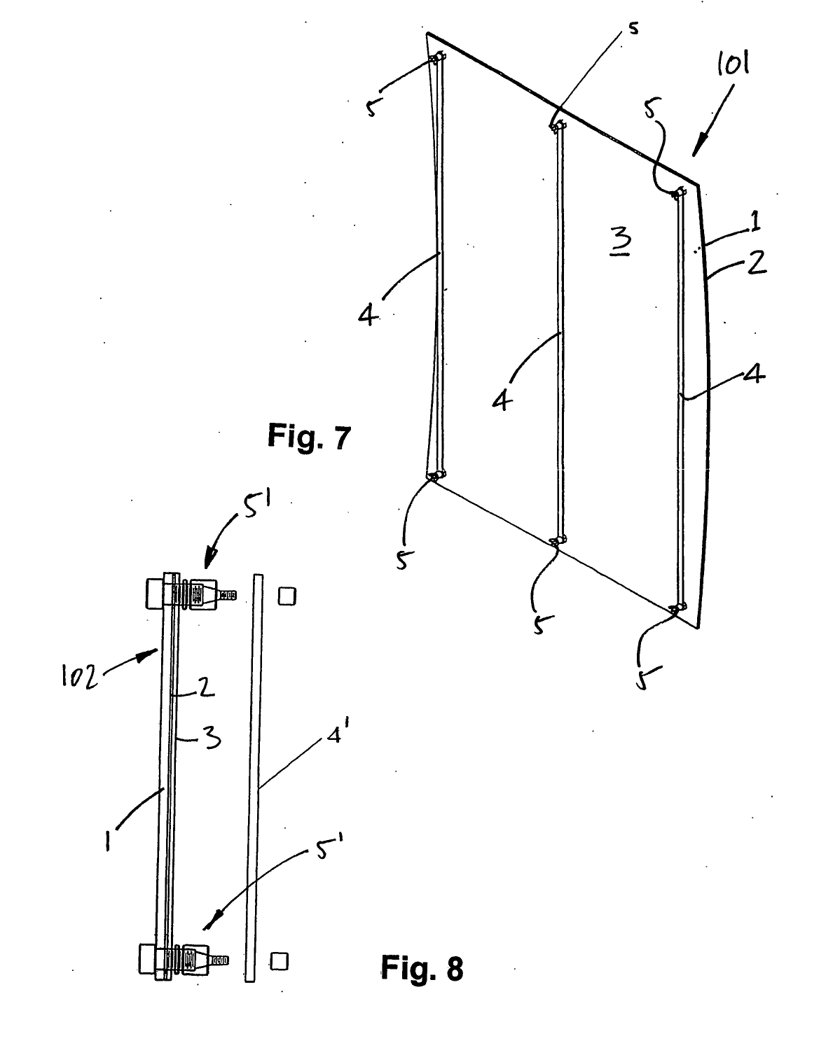

Referring to FIG. 7, a lenticular display assembly in accordance with another embodiment of the present invention is generally at 101. In addition to the lenticular lens 1 and the image panel 2, a backplate 3 is provided such that the image panel 2 is sandwiched between the lenticular lens 1 and the backplate 3. Tension bars 4 are provided with fasteners 5. The tension bars 4 have connection holes are opposed ends, through which the fasteners 5 are received.

The lens 1, panel 2 and backplate 3 each have connection holes that are in register when the lens 1 and the panel 2 are aligned in position and orientation (with the registration done for instance with the table 50 of the present invention). The fasteners 5 are passed through the connection holes in the lens 1, the panel 2 and the backplate 3, whereby the lens 1 and the panel 2 are registered in position and orientation.

The distance between connection holes in each of the tension bars 4 is smaller than the distance between vertically aligned connection holes in the lens 1, the panel 2 and the backplate 3, such that the lens 1, the panel 2 and the backplate 3 are curved, as seen in FIG. 7, when the tension bars 4 are used.

Referring to FIG. 8, a tension plate 4′ (as opposed to individual tension bars 4 of FIG. 7) is illustrated with fasteners 5′ in a lenticular display assembly 102. The fasteners 5′ enable the lens 1, the image panel 2 and the backplate 3 to be interconnected, in an aligned relationship, prior to curving these panels to press the image panel 2 against the lens 1. Each of the fasteners 5′ has a pair of nuts, one of which will be used to interconnect the panels and the other of which will be used to interrelate the fasteners 5′ with the tension plate 41, so as to curve the panels. It is pointed out that because of the spacing between the panels and the tension plate 4′, panels may be curved so as to show either a concave or a convex curvature from an front of the lenticular display assembly made therewith.

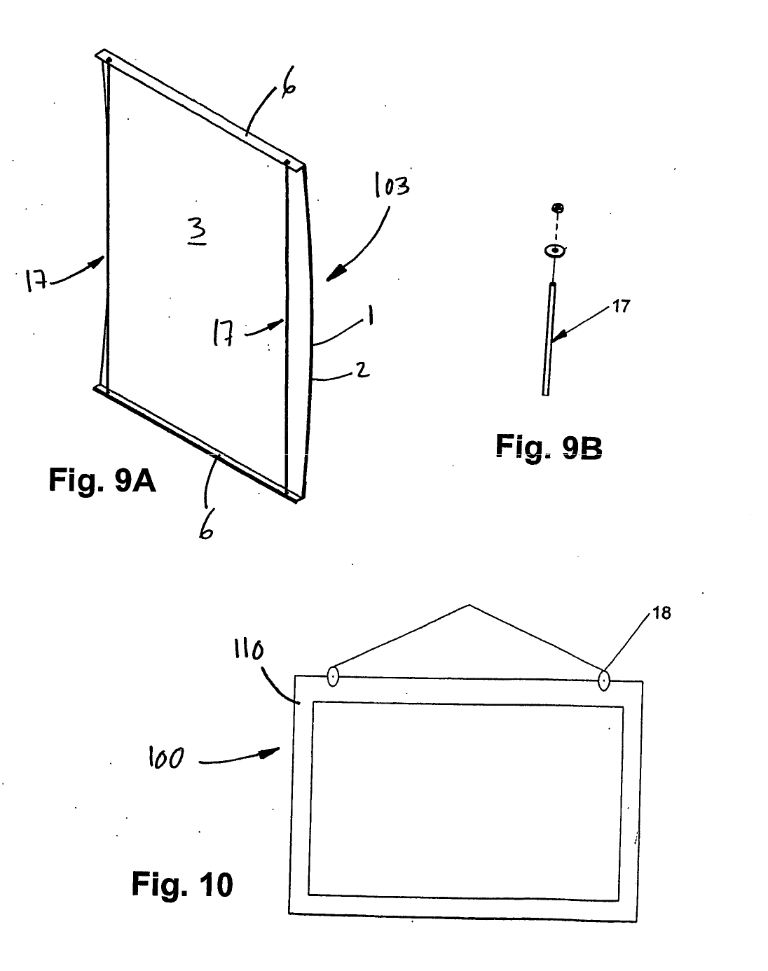

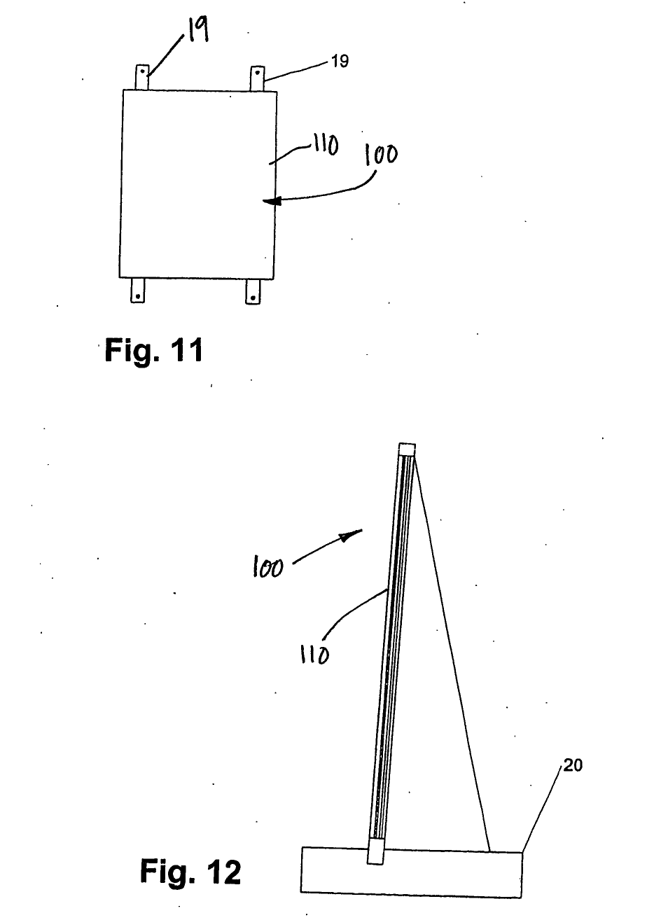

Referring to FIGS. 9A and 9B, the compression means 17 for a lenticular display assembly 103 are a pair of threaded rods with washers and nuts, used in combination with brackets 6 that curve the lens 1, the image panel 2 and the backplate 3. In FIGS. 10, 11 and 12, various support configurations are illustrated to show how the lenticular display assembly 100 in accordance with the present invention (or any other lenticular display assembly in accordance with the embodiments of the present invention) may be used to expose images. In FIG. 10, the lenticular display assembly 100 is shown in a casing 110, supported by a suspension cable 18. In FIG. 11, connection bars 19 are used with the lenticular display assembly 100 in the casing 110. Finally, a support base 20 supports the lenticular display assembly 100 in the casing 110.

It is within the ambit of the present invention to cover any obvious modifications of the embodiments described herein, provided such modifications fall within the scope of the appended claims.

1. A lenticular display assembly, comprising:
an image panel having a composite image and connection holes;
a lenticular lens panel adapted to display a lenticular image from a composite image and having connection holes;
connection means provided to releasably connect the image panel to the lenticular lens panel by cooperating with the connection holes of the image panel and the lenticular lens panel such that the image panel and the lenticular lens panel are in an aligned relationship; and
compression means provided to press the image panel and the lenticular lens panel against one another;
whereby the lenticular image is displayed by the lenticular lens panel and the image panel being interconnected by the connection means and the compression means.

2. The lenticular display assembly according to claim 1 wherein the compression means cooperates with any one of the image panel, the lenticular lens panel and the connection means to curve the image panel and the lenticular lens panel connected to one another by the connection means, such that the image panel and the lenticular lens panel are pressed against one another.

3. The lenticular display assembly according to claim 2, wherein the compression means has a backplate sandwiching the image panel between the backplate and the lenticular lens panel, and a tension member interconnecting the connection means at opposed ends of the panels such that a curve is produced in the panels and in the backplate.

4. The lenticular display assembly according to claim 1, wherein the connection means are fasteners received in holes in the panels.

5. The lenticular display assembly according to claim 1, further comprising a light source behind the image panel so as to illuminate the lenticular image.

6. The lenticular display assembly according to claim 3, wherein the tension member is at least one bar having connection holes at opposed ends thereof for being connected to the connection means, a distance between the connection holes being smaller than a distance between the fasteners at opposed ends of the panels.

7. A method for displaying a lenticular image, comprising the steps of:
i) providing a lenticular lens panel and an image panel;
ii) positioning the lenticular lens panel onto the image panel such that the lenticular lens panel is in a desired alignment relationship with respect to a composite image on the image panel; and
iii) pressing the panels such that the image panel is pressed against the lenticular lens panel;
whereby a lenticular image is displayed by the combination of the panels.

8. The method according to claim 7, wherein the step iii) is effected by bending the panels such that the panels re curved together.

9. The method according to claim 7 further comprising a step of iv) emitting light from behind a rear surface of the image panel, so as to illuminate the lenticular image.

10. The method according to claim 7, further comprising steps of iv) releasing the pressure between the panels and removing the image panel from the lenticular lens panel, and repeating the steps i), ii) and iii) with another one of the image panels.

11. The method according to claim 7, wherein the step ii) is achieved by passing fasteners through prealigned connection holes in the panels.

12. A method for aligning an image panel with a lenticular lens panel, comprising the steps of:
i) positioning at least one image panel on a support surface;
ii) positioning a reference lens panel on the at least one image panel, the reference lens panel having a known alignment with respect to the lenticular lens panel;
iii) adjusting a position and orientation of the reference lens panel with the at least one image panel such that the reference lens panel is aligned with the at least one image panel to display a desired lenticular image; and
iv) creating connection holes in the at least one image panel;
whereby the image panel is aligned for the lenticular lens panel as a function of said known alignment, for a subsequent interconnection of the image panel with the lenticular lens panel using the connection holes.

13. The method according to claim 10, wherein the steps i) to iv) are performed with a plurality of the at least one image panel stacked onto one another.

14. The lenticular display assembly according to claim 2, further comprising a light source behind the image panel so as to illuminate the lenticular image.

15. The lenticular display assembly according to claim 3, further comprising a light source behind the image panel so as to illuminate the lenticular image.

16. The method according to claim 8 further comprising a step of iv) emitting light from behind a rear surface of the image panel, so as to illuminate the lenticular image.
